(19) United States
(12) Patent Application Publication
(10) Pub. No.: US 2018/0053110 A1
(43) Pub. Date: Feb. 22, 2018

(54) METHOD OF PREDICTING CRIME OCCURRENCE IN PREDICTION TARGET REGION USING BIG DATA

(71) Applicant: THE CATHOLIC UNIVERSITY OF KOREA INDUSTRY -ACADEMIC COOPERATION FOUNDATION, Seoul (KR)

(72) Inventors: Hang-Bong KANG, Seoul (KR); Hyeon-Woo KANG, Seoul (KR)

(73) Assignee: THE CATHOLIC UNIVERSITY OF KOREA INDUSTRY-ACADEMIC COOPERATION FOUNDATION, Seoul (KR)

(21) Appl. No.: 15/682,698

(22) Filed: Aug. 22, 2017

(30) Foreign Application Priority Data
Aug. 22, 2016 (KR) 10-2016-0106209

(51) Int. Cl. G06N 7/00; G06Q 50/26; G06Q 10/04; G08B 29/18; H04W 4/02

(52) U.S. Cl. CPC G06N 7/005; G06Q 50/265; H04W 4/028; G08B 29/185; G06Q 10/04

(57) ABSTRACT

Disclosed is a method of predicting crime occurrence in a prediction target region using big data, the method including: collecting crime prediction data of the prediction target region from a plurality of data domains; collecting crime occurrence data of crime that occurred in the prediction target region during a preset period of time from a crime occurrence record domain; analyzing the crime prediction data and the crime occurrence data of each of the data domains according to a statistical analysis, and extracting meaningful data of the crime prediction data as available data by each of the data domains; and predicting crime occurrence by applying the available data to a pre-registered deep learning algorithm, wherein the available data is classified into a plurality of data groups according to a data type, and the deep learning algorithm includes: a first deep neural network; a second deep neural network; and an output.

### CROSS REFERENCE TO RELATED APPLICATION

The present application claims priority to Korean Patent Application No. 10-2016-0106209, filed Aug. 22, 2016, the entire contents of which is incorporated herein for all purposes by this reference.

### BACKGROUND OF THE INVENTION

### Field of the Invention

The present invention relates generally to a method of predicting crime occurrence in a prediction target region using big data. More particularly, the present invention relates to a method of predicting crime occurrence in a prediction target region using big data, whereby the method can accurately predict crime occurrence in a prediction target region by using big data collected from a plurality of data domains and by considering features of the data collected from the plurality of data domains.

### Description of Related Art

Crimes are of great concern in society due to the serious damages caused thereby. Accordingly, various studies on crime prevention have been promoted. Such a crime study has been generally conduced by analyzing patterns and correlations between various types of data and real crime occurrences and by using various statistical methods.

However, recently, due to advances in technology, studies on techniques for crime prevention have been conduced based on big data and machine learning. In other words, in addition to a method of simply and statically analyzing patterns between data and crime occurrences, a system for predicting crime occurrence through a real machine learning model has been developed.

In addition, recently, crime prediction systems have been applied to a real environment, and an effective patrol path for crime prevention has been configured based on results of such crime prediction systems. Such systems have contributed to a decrease in crime.

Generally, a crime prediction system based on machine learning learns crime occurrence patterns through records of past crime occurrences, and further additionally collects and uses various types of information that represent features of a corresponding region such as demography, economy, education, etc.

Conventional studies for predicting crime occurrences have been conduced by using single data types such as demography, economy, education, etc., and analyzing correlations between the corresponding data and crimes that have actually occurred. In one embodiment, Korean Patent Application Publication No. 10-2014-0100173 discloses “method for providing a crime forecast service using weather”, and provides a method of providing to a user crime prediction information according to present weather information or weather forecast information by databasing crime occurrence possibilities according to whether information.

In another embodiment, Korean Patent No. 10-1628938 discloses “system and method for residential burglary prediction”, and provides a method of designing a prediction algorithm by analyzing correlations between three-dimensional spatial features of a target region and offender behavior features.

Since prediction methods provided by the above patents use only a single type of data, for example, weather information, or offender behavior feature, etc., when a correlation between the corresponding data type and the actual crime occurrence is small, it is difficult to guarantee the prediction accuracy. In addition, it is difficult to avoid inaccuracy caused by a result depending on accident.

Recently, due to advances in technology, it has become easier to collect mass information due to the development of big data. Accordingly, there is provided an environment in which data used for crime prediction and various types of other data may be collected from various data domains.

Accordingly, an increase in data that may be used for crime prediction may improve prediction performance. However, as described above, it is difficult to solve the described problem by using a large amount of a single data type. In addition, it may be a factor of degrading prediction performance when various types of collected data are simply used. Accordingly, use of data that is irrelevant to crime occurrence prediction may degrade prediction performance since such data disenables proper leaning of correlations and patterns between data of a machine learning model and crime occurrence.

In addition, conventional crime prediction methods use prediction methods that disregard differences between data domains in use. Data that may be used for crime occurrence prediction is various and may include crime occurrence records, demography, economy, etc. However, since data is respectively collected from different data domains, data has a data distribution and feature difference from each other. Thus, it is difficult for a prediction method that disregards differences between data domains to guarantee the prediction accuracy.

The foregoing is intended merely to aid in the understanding of the background of the present invention, and is not intended to mean that the present invention falls within the purview of the related art that is already known to those skilled in the art.

### Documents of Related Art

(Patent Document 1) Korean Patent Application Publication No. 10-2014-0100173; and

(Patent Document 2) Korean Patent No. 10-1628938

### SUMMARY OF THE INVENTION

Accordingly, the present invention has been made keeping in mind the above problems occurring in the related art, and the present invention is intended to propose a method of predicting crime occurrence in a prediction target region using big data, whereby the method can accurately predict crime occurrence in a prediction target region by using big data collected from a plurality of data domains and by considering features of the data collected from the plurality of data domains.

In order to achieve the above object, according to one aspect of the present invention, there is provided a method of predicting crime occurrence in a prediction target region using big data, the method including: step a of collecting crime prediction data of the prediction target region from a plurality of data domains; step b of collecting crime occurrence data of crime that occurred in the prediction target region during a preset period of time from a crime occurrence record domain; step c of analyzing the crime prediction data and the crime occurrence data of each of the data domains according to a statistical analysis, and extracting meaningful data of the crime prediction data as available data by each of the data domains; and step d of predicting crime occurrence by applying the available data to a pre-registered deep learning algorithm, wherein the available data is classified into a plurality of data groups according to a data type, and the deep learning algorithm includes: a first deep neural network configured with a plurality of feature representation layers provided corresponding to each of the data groups, and in which feature representation learning is executed by receiving the available data of corresponding data groups as an input; a second deep neural network including a joint feature representation layer fusing data in a feature level by receiving outputs of the respective feature representation layers as an input; and an output function calculating probability of crime occurrence based on an output of the joint feature representation layer.

Herein, the data domains may include at least two of a demographic domain, an economic domain, an education domain, a housing domain, a weather domain, and an image domain of the prediction target region, and the crime prediction data may include: demographic data collected from the demographic domain; economic data collected from the economic domain; education data collected from the education domain; housing data collected from the housing domain; weather data collected from the weather domain; and image data collected from the image domain.

In addition, the step c may include: step c1 of extracting available data by applying crime prediction data included in at least one of the data domains to a Pearson correlation coefficient analysis; and step c2 of extracting available data by applying crime prediction data included in remaining data domains to a Kruskal-Wallis H test.

In addition, in the step c1, the demographic data, the economic data, the education data, the housing data, and the weather data may be applied to the Pearson correlation coefficient analysis, and in the step c2, the image data may be applied to the Kruskal-Wallis H test.

In addition, the image data may be collected from the prediction target region in terms of sampling points, and the step c2 may include: step c21 of extracting feature information from the image data; step c22 of grouping the feature information in a plurality of feature groups by applying the feature information to a k-means clustering algorithm; step c23 of applying a number of crime occurrences within each of the sampling points and the image data of a corresponding sampling point to the Kruskal-Wallis H test based on the crime occurrence data, and analyzing a statistical meaningful difference between the number of crime occurrences according to feature information of each of the feature groups; and step c24 of extracting available data based on analysis results of the step c23.

In addition, in the step c23, a post hoc test between the feature groups may be performed by executing a Dunn's test using a Bonferroni-type adjustment of p-values.

In addition, the output function may include a softmax function.

According to the present invention configured as above, there is provided a method of predicting crime occurrence in a prediction target region using big data, whereby the method can accurately predict crime occurrence in a prediction target region by using big data collected from a plurality of data domains and by considering features of the data collected from the plurality of data domains.

It will be appreciated by persons skilled in the art that that the effects that could be achieved with the present invention are not limited to what has been particularly described hereinabove and other advantages of the present invention will be more clearly understood from the following detailed description.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a view showing a configuration of a system for predicting crime occurrence in a prediction target region using big data according to the present invention;

FIGS. 2 and 3 are views showing a method of predicting crime occurrence in a prediction target region using big data according to the present invention;

FIG. 4 is a view showing an example of a sampling point that is sampled in a 0.001 latitude-longitude unit of Chicago;

FIG. 5 is a view showing a configuration of a deep neural network for performing a deep learning algorithm according to the present invention; and

FIG. 6 is a view showing a hotspot map in which a prediction result of the crime occurrence prediction method according to the present invention is displayed.

### DETAILED DESCRIPTION OF THE INVENTION

Hereinbelow, exemplary embodiments of the present invention will be described in detail with reference to the accompanying drawings.

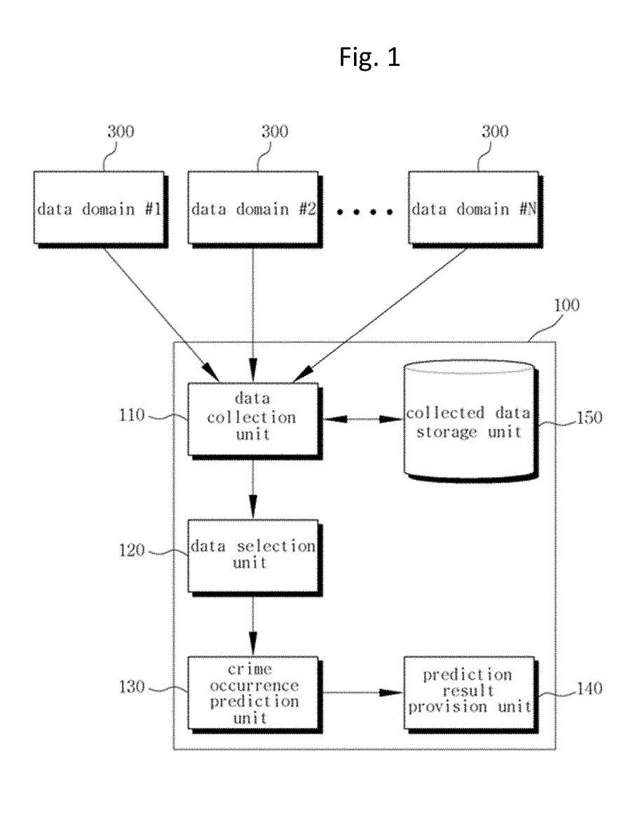

FIG. 1 is a view showing a configuration of a system 100 for predicting crime occurrence in a prediction target region using big data. Describing with reference to FIG. 1, the crime occurrence prediction system 100 according to the present invention includes: a data collection unit 110, a data selection unit 120, and a crime occurrence prediction unit 130. In addition, the crime occurrence prediction system 100 according to the present invention may include: a collected data storage unit 150; and a prediction result provision unit 140.

The data collection unit 110 collects crime prediction data of a prediction target region from a plurality of data domains 300. Herein, the crime prediction data collected by the data collection unit 110 and crime occurrence data that will be described later are stored in the collected data storage unit 150.

For example, in the present invention, the data collection unit 110 collects crime prediction data stored in the data domains 300 by being connected to each of the data domains 300 through a communication network such as Internet. However, the data collection unit 110 may be configured to receive crime prediction data from managers of respective data domains 300 or to receive data through a storage medium.

For example, in the present invention, the data domains 300 include a demographic domain 310, an economic domain 340, an education domain 330, a housing domain 320, a weather domain 350, and an image domain 370. However, the number and types of data domains are not limited thereto and one or more of the examples may be excluded.

Accordingly, the crime prediction data according to the present invention may include: demographic data collected from the demographic domain 310; economic data collected from the economic domain 340; education data collected from the education domain 330; housing data collected from the housing domain 320; weather data collected from the weather domain 350; and image data collected from the image domain 370. Examples of data domains 300 and collecting methods thereof, and examples of the crime prediction data will be described later.

Meanwhile, the data collection unit 110 collects crime occurrence data of crime that occurred in the prediction target region during a preset period of time from a crime occurrence record domain.

Then, the data selection unit 120 analyzes crime prediction data of each of the data domains 300 and crime occurrence data according to a statistical analysis by using the crime prediction data and the crime occurrence data collected by the data collection unit 110. In addition, the data selection unit 120 extracts data that is determined to be meaningful data of the crime prediction data as available data by applying a statistical analysis. Accordingly, meaningless crime prediction data extracted from each of the data domains 300 is removed, and meaningful data is used as available data to predict possibility of crime occurrence, thus prediction accuracy is improved. Herein, a method of extracting available data by the data selection unit 120 will be described later.

The crime occurrence prediction unit 130 predicts crime occurrence in the prediction target region by applying the available data extracted by the data selection unit 120 to a pre-registered deep learning algorithm.

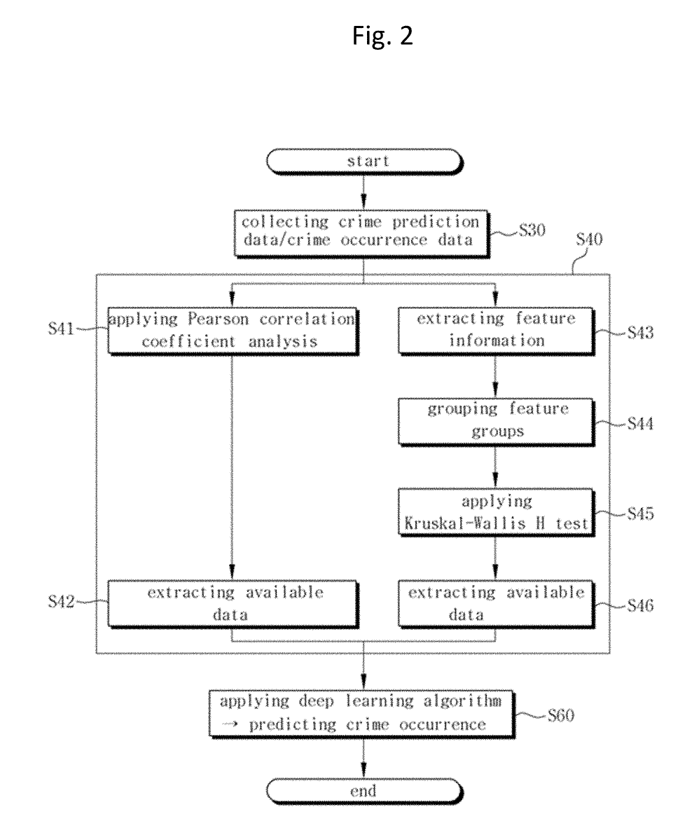

Hereinbelow, with reference to FIGS. 2 to 6, a method of predicting crime occurrence in a prediction target region using big data according to the present invention will be described in detail. Herein, in describing the crime occurrence prediction method according to the present invention, for example, the prediction target region is described as Chicago, USA, and the crime prediction data is described as real data of Chicago.

First, in step S30, crime prediction data is collected from a plurality of data domains 300, and crime occurrence data is collected from a crime occurrence record domain 360. Table 1 shows an actual example of data domains 300 used for collecting the crime prediction data and the crime occurrence data of Chicago, USA.

TABLE 1

| Data Type | Data Domain 300 | Remark |
|---|---|---|
| Crime | City of Chicago | http://data.cityofchicago.org |
| occurrence | Data Portal | |
| data | | |
| Demographic | AmericanFactFinder | http://factfinder.census.gov |
| data | | |
| Housing | | |
| data | | |
| Education | | |
| data | | |
| Economic | | |
| data | | |
| Weather | Weather | http://www.wunderground.com/ |
| data | Underground | |
| Image date | Google Street View | http://developers.google.com/ |
| | | maps/documentation/streetview/ |

Describing with reference to Table 1, the crime occurrence data is collected for crime that occurred during a predetermined period of time, in the present invention, for example, the crime occurrence data is described as crime occurrence data occurred in 2014. A crime occurrence report includes data regarding a crime type, and latitude-longitude coordination data of a location in which crime has occurred.

Demographic data, housing data, education data, and economic data may be collected from American FactFinder. Accordingly, data with types different from each other may be collected from a single data domain 300. In the present invention, names of data domains 300 are designated according to data types of corresponding crime prediction data, and it does not mean that the data domains 300 are physically different, or expose different targets to be managed. Herein, in the present invention, data of 2014 American community survey (ACS) is used, and the data includes information about a census tract of Chicago, and an incomplete data set having a missing value may be removed therefrom.

For example, weather data, as shown in [Table 1], is collected from a Weather Underground API, and image data is collected from a Google street view image API. Herein, the weather data is collected from daily climate records of Chicago, and includes information about an average value, the maximum value, the minimum value, etc. of the weather and also includes climate event information such as snow, rain, hail, tornado, etc. In the present invention, for example, an average humidity and snow data which have a missing value are not used for crime prediction data, and data about hail and tornado which did not occur in 2014 is removed.

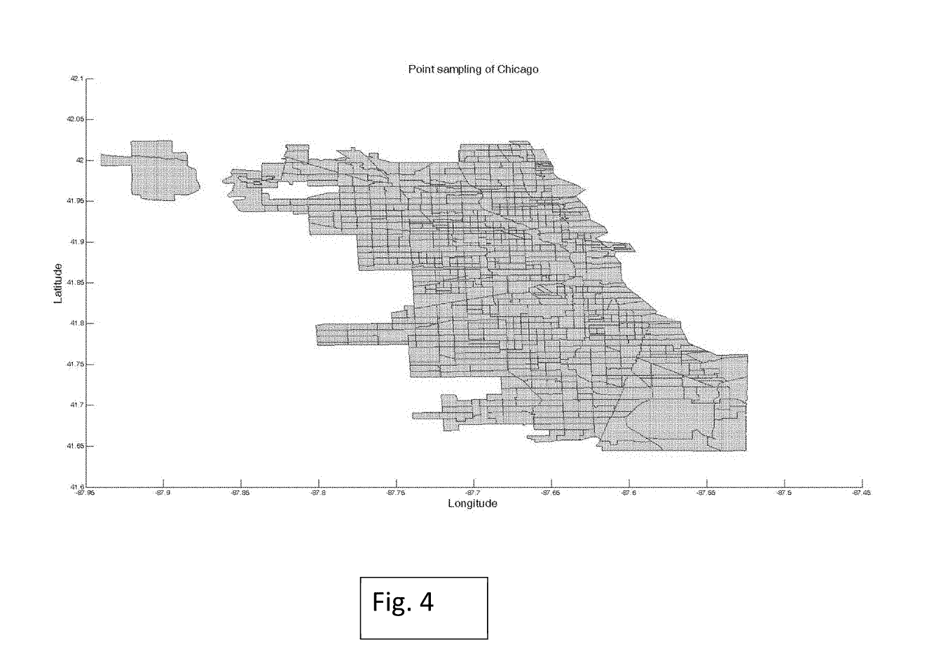

For example, the image data is collected by using a latitude-longitude coordination value. For example, the image data is obtained by using a point sampling within a boundary of Chicago. For example, in the present invention, images of all 0.001 latitude-longitude units may be obtained. FIG. 4 shows an example of a sampling point that is sampled in a 0.001 latitude-longitude unit of Chicago in the present invention.

In collecting crime prediction data of respective data types as above, when the data includes a missing value, additional data may be collected from other data domains 300 that provide the same type data. In one embodiment, there may be a case that there is no image for a sampling point when collecting image data from a Google street view image API. Herein, image data for a corresponding sampling point may be obtained from a Google maps geocoding API.

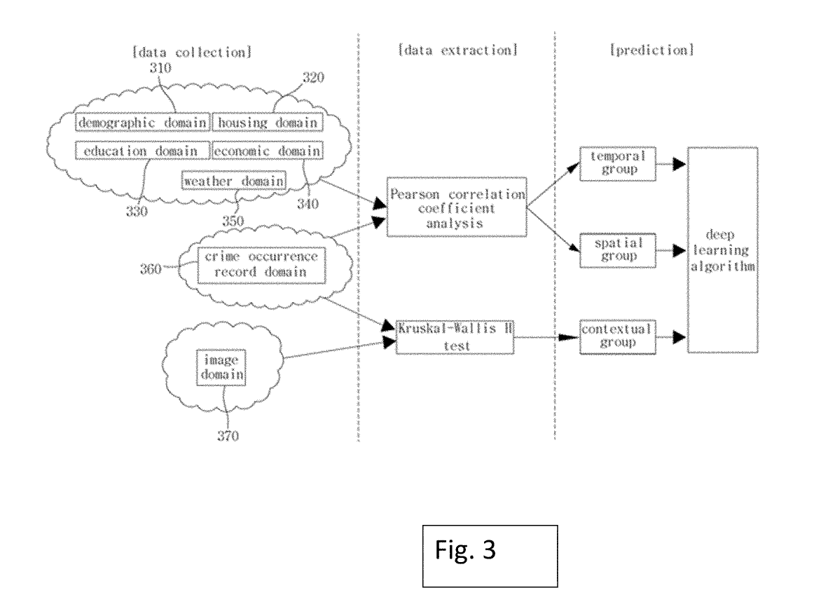

Describing again with reference to FIGS. 2 and 3, when the collection of the crime prediction data is completed as above, in step S40, available data by each of the data domains 300 is extracted from meaningful data by analyzing the crime prediction data of each of the data domains 300 and the crime occurrence data according to a statistical analysis as described above.

For example, in the present invention, as shown in FIGS. 2 and 3, in step S41, crime prediction data included in at least one of the data domains 300 is applied to a Pearson correlation coefficient analysis, and then in step S42, available data of a corresponding data domain 300 is extracted. In steps S43 to S45, crime prediction data included in a remaining data domain 300 is applied to a Kruskal-Wallis H test, and then in step S46, available data of a corresponding data domain 300 is extracted.

For example, in the present invention, demographic data, economic data, education data, housing data, and weather data are applied to the Pearson correlation coefficient analysis, and image data is applied to the Kruskal-Wallis H test.

Describing in more detail, the demographic data, the housing data, the education data, and the economic data obtain a number of crime occurrences of a census tract from the crime occurrence data, and correlations between each data and the number of crime occurrences may be calculated. In case of weather data, a correlation with a number of crime occurrences during a single day may be calculated.

After that, data having a statistically meaning, for example, p<0.05, and which satisfies a condition of r<−0.2 and r>0.2 as an analysis result is extracted as available data, and the remaining data is determined to be useless for predicting the crime occurrence, and is removed therefrom.

In case of image data, since the image data has a form different from the described demographic data and the economic data, and it is impossible for the image date to analyze a correlation by using the Pearson correlation coefficient analysis, thus the above Kruskal-Wallis H test is applied thereto as described above.

Describing in more detail, in step S43, feature information is extracted from the image data. As described above, in the present invention, since the image data is extracted in a 0.001 latitude/longitude coordination unit, feature information is extracted from the image data in each coordination unit. For example, a result of a first fully connected layer (for example, 4096 dimension) of Alexnet which is one of a convolutional neural network (CNN) may be extracted as feature information.

Then, in step S44, the feature information is grouped in a plurality of feature groups by applying a k-means clustering algorithm thereto. For example, in the present invention, a k value may be set to 10. Alternatively, a feature information extracting method or the k value may be randomly set according to a situation of data.

Then, in step S45, by using the crime occurrence data, whether or not a statistically meaningful difference exists between a number of crime occurrences within a sampling point of image data and a number of crime occurrences according to the feature information of each of the feature groups in which the Kruskal-Wallis H test is applied to image data of a corresponding sampling point is analyzed.

Herein, in the present invention, a post hoc test between feature groups is performed by executing a Dunn's test using a Bonferroni-type adjustment of p-values. In step S46, meaningless data is removed by the above test, and the available data is extracted from the meaningful data.

In step S51, the available data that is extracted by each of the data domains 300 as above, in other words, by each type of crime prediction data, is applied to a deep learning algorithm to predict crime occurrence as described above.

The available data is classified into a plurality of data groups according to a data type. For example, in the present invention, the available data is classified into three data groups: a temporal group, a spatial group, and a contextual group.

Available data extracted from the demographic data, the housing data, the education data, and the economic data are grouped in the spatial group. Available data extracted from the weather data and the crime occurrence data are grouped in the temporal group. Finally, available data extracted from the image data is grouped in the contextual group.

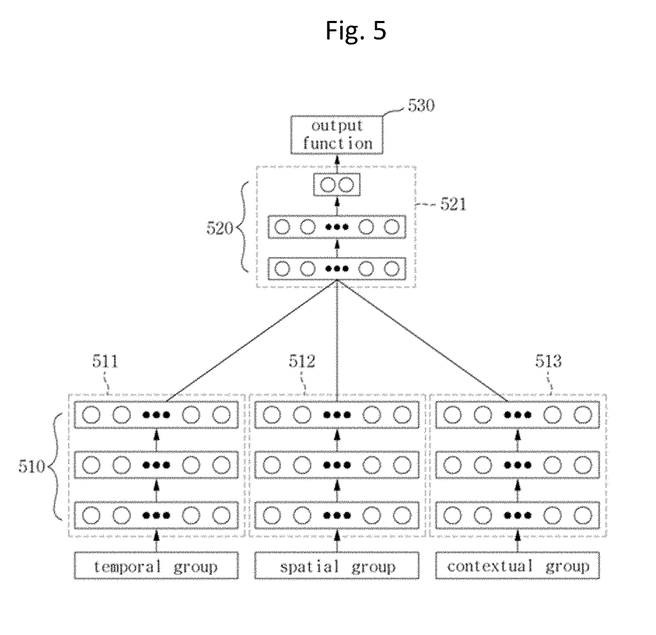

FIG. 5 is a view showing a configuration of a deep neural network for performing the deep learning algorithm according to the present invention. Describing with reference to FIG. 5, the deep learning algorithm according to the present invention may include: a first deep neural network 510; a second deep neural network 520; and an output function 530.

The first deep neural network 510 is configured with a plurality of feature representation layers 511, 512, and 513 which are provided corresponding to each of the data groups. Herein, available data included in each of the data groups is respectively input to corresponding feature representation layers 511, 512, and 513 as a raw data vector. Respective representation layers 511, 512, and 513 are output in feature vectors by independently operating and performing feature representation learning.

Then, the feature vectors respectively output from the feature representation layers 511, 512, and 513 are input to a joint feature representation layer 521 constituting the second deep neural network 520 to perform data fusion in a single feature vector since data is combined in a feature level.

After, the single feature vector is input to the output function 530 and is calculated to probability of crime occurrence. For example, in the present invention, a softmax function is used as the output function 530. The softmax function is a function performing a classification and outputs a probability value for each class, and the summation of the probability values of the classes becomes 1. Accordingly, in the present invention, the class is classified into: a crime occurrence class and a crime non-occurrence class, and probability values of both classes are output from the softmax function, thus crime occurrence may be predicted.

Herein, since a probability value may be output in terms of sampling points as described above, the prediction result provision unit 140 shown in FIG. 1 may generate and output a map of the prediction target region, for example, a hotspot map visually displaying the crime occurrence possibility on a map of Chicago.

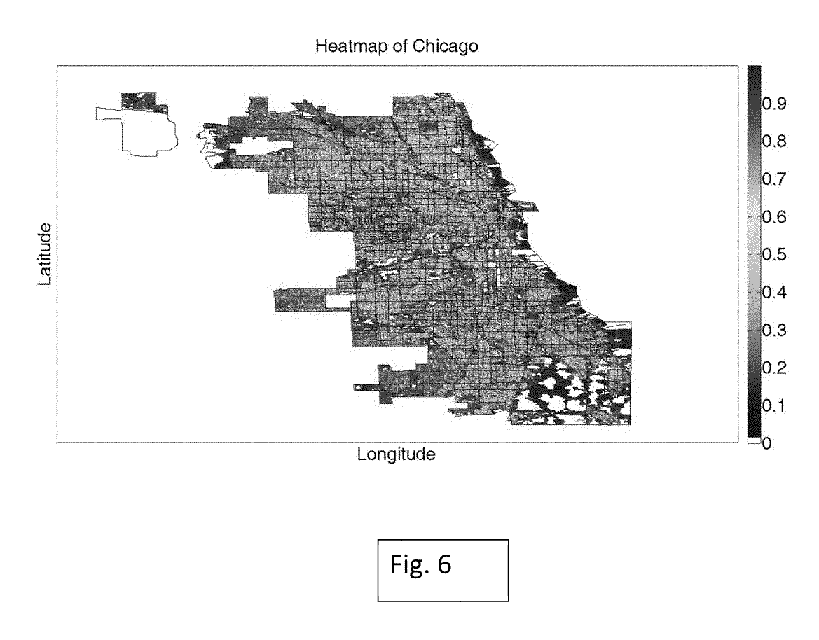

FIG. 6 is a view showing a hotspot map in which a prediction result of the crime occurrence prediction method according to the present invention is displayed, the prediction is made by using data from January to November in 2014 of Chicago, USA.

In order to test the prediction accuracy of the crime occurrence prediction method according to the present invention, results obtained by using a Kernel density estimation method of a conventional prediction method, and obtained by using a prediction method using a support vector machine are respectively compared with an actual crime that occurred in December of 2014. As a result of comparison, it is confirmed that the accuracy of the crime occurrence prediction method according to the present invention is improved by 17% compared to the conventional prediction method.

It is apparent to those skilled in the art that, although some embodiments of the present invention are described, modifications of the embodiments are made without departing from the principles and spirit of the present invention. The scope of the present invention is defined by the appended claims and their equivalents.

What is claimed is:

1. A method of predicting crime occurrence in a prediction target region using big data, the method comprising:
step (a) of collecting crime prediction data of the prediction target region from a plurality of data domains;
step (b) of collecting crime occurrence data of crime that occurred in the prediction target region during a preset period of time from a crime occurrence record domain;
step (c) of analyzing the crime prediction data and the crime occurrence data of each of the data domains according to a statistical analysis, and extracting meaningful data of the crime prediction data as available data by each of the data domains; and
step (d) of predicting crime occurrence by applying the available data to a pre-registered deep learning algorithm,
wherein
the available data is classified into a plurality of data groups according to a data type, and
the deep learning algorithm includes:
a first deep neural network configured with a plurality of feature representation layers provided corresponding to each of the data groups, and in which feature representation learning is executed by receiving the available data of corresponding data groups as an input;
a second deep neural network including a joint feature representation layer fusing data in a feature level by receiving outputs of the respective feature representation layers as an input; and
an output function calculating probability of crime occurrence based on an output of the joint feature representation layer.

2. The method of claim 1, wherein the data domains include at least two of a demographic domain, an economic domain, an education domain, a housing domain, a weather domain, and an image domain of the prediction target region, and the crime prediction data includes:
demographic data collected from the demographic domain;
economic data collected from the economic domain;
education data collected from the education domain;
housing data collected from the housing domain;
weather data collected from the weather domain; and
image data collected from the image domain.

3. The method of claim 2, wherein the step (c) includes:
step (c1) of extracting available data by applying crime prediction data included in at least one of the data domains to a Pearson correlation coefficient analysis; and
step (c2) of extracting available data by applying crime prediction data included in remaining data domains to a Kruskal-Wallis H test.

4. The method of claim 3, wherein in the step (c1), the demographic data, the economic data, the education data, the housing data, and the weather data are applied to the Pearson correlation coefficient analysis, and in the step (c2), the image data is applied to the Kruskal-Wallis H test.

5. The method of claim 4, wherein the image data is collected from the prediction target region in terms of sampling points, and the step (c2) includes:
step (c21) of extracting feature information from the image data;
step (c22) of grouping the feature information in a plurality of feature groups by applying the feature information to a k-means clustering algorithm;
step (c23) of applying a number of crime occurrences within each of the sampling points and the image data of a corresponding sampling point to the Kruskal-Wallis H test based on the crime occurrence data, and analyzing a statistical meaningful difference between the number of crime occurrences according to feature information of each of the feature groups; and
step (c24) of extracting available data based on analysis results of the step (c23).

6. The method of claim 5, wherein in the step (c23), a post hoc test between the feature groups is performed by executing a Dunn's test using a Bonferroni-type adjustment of p-values.

7. The method of claim 1, wherein the output function includes a softmax function.
